(19) United States
(12) Patent Application Publication
(10) Pub. No.: US 2023/0025338 A1
(43) Pub. Date: Jan. 26, 2023

(54) CAPILLARY STRUCTURES

(71) Applicant: Hewlett-Packard Development Company, L.P., Spring, TX (US)

(72) Inventors: Robert S Wickwire, Corvallis, OR (US); David N Olsen, Corvallis, OR (US); Michael W Cumbie, Corvallis, OR (US)

(73) Assignee: Hewlett-Packard Development Company, L.P., Spring, TX (US)

(21) Appl. No.: 17/783,049

(22) PCT Filed: Dec. 18, 2019
(86) PCT No.: PCT/US2019/067160

§ 371 Date: Jun. 7, 2022

(51) Int. Cl. B41J 2/175

(52) U.S. Cl. CPC B41J 2/17513; B41J 2/17556; B41J 2002/17573

(57) ABSTRACT

An example fluidic device comprises a fluid reservoir having a porous media arranged within the reservoir, and a capillary structure. The capillary structure is in fluid communication with the porous media and the fluid reservoir and has tuned parameters corresponding to parameters of the fluid reservoir and the porous media. Wherein fluid within the capillary structure is to change level in response to pressure changes in the reservoir.

### BACKGROUND

Fluids may flow through channels (e.g., microchannels) of fluidic dies and may be manipulated by the dies, including being ejected in the form of fluid droplets. Fluidic dies may use capillary action to pull fluids into fluid channels of the dies. Fluidic dies may also use fluid actuators to cause movement of fluid within the fluid channels. Fluid reservoirs may be in fluid communication with the fluid dies and may include porous media (e.g., solid foam) to assist in delivering fluid to the fluid dies.

### BRIEF DESCRIPTION OF THE DRAWINGS

Various examples will be described below by referring to the following figures.

FIG. 1 is a block diagram of an example fluidic device;

FIG. 2 illustrates an example fluid path of a capillary structure;

FIGS. 3A-3C are cross-sectional side views of an example fluidic device;

FIG. 4 is cross-sectional side view of another example fluidic device;

FIG. 5 is chart of capillary pressure in inches H₂O versus time in seconds according to one implementation;

FIGS. 6A-6C are schematic diagrams illustrating example sensing devices for a capillary structure;

FIG. 7 is a schematic diagram illustrating aspects of an example fluidic system;

FIGS. 8A-8D illustrate aspects of an example fluidic device;

FIGS. 9A-9C illustrate aspects of another example fluidic device;

FIG. 10 is a block diagram of an example fluidic system; and

FIGS. 11 and 12 are flow diagrams of example methods related to operation of a fluidic device with a capillary structure.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

References throughout this specification to one implementation, an implementation, one example, an example, and/or the like means that a particular feature, structure, characteristic, and/or the like described in relation to a particular implementation and/or example is included in at least one implementation and/or example of claimed subject matter. Thus, appearances of such phrases, for example, in various places throughout this specification are not necessarily intended to refer to the same implementation and/or example or to any one particular implementation and/or example. Furthermore, it is to be understood that particular features, structures, characteristics, and/or the like described are capable of being combined in various ways in one or more implementations and/or examples and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

At times, fluids may be manipulated in fluidic dies, which are blocks of semiconducting material through which both electric signals (e.g., to and from integrated circuit elements) and fluids (e.g., liquids and/or gasses) may travel. In one example, fluids may traverse fluid channels (e.g., microchannels) in a fluidic die in response to actuation of fluid actuators (e.g., thermal resistors, piezo elements, etc.) the actuation of which may occur in response to electric signals. Such operation may be of interest to apply printing fluids to a substrate (e.g., for two-dimensional (2D) or three-dimensional (3D) printing), for manipulating and/or testing biological samples (e.g., blood tests, fluid analysis and/or diagnostics, etc.). Consequently, there may be a desire to deliver fluid to fluidic dies, such as to enable functionality outlined in the preceding examples. Delivering fluid to a fluidic die presents challenges, such as related to complexity and/or cost. For instance, active fluid delivery systems can add cost and complexity to a system.

The use of a porous media, such as solid foams (referred to herein as foam), within a fluid reservoir in fluid communication with the fluidic die provides a simple and inexpensive approach to delivering fluid to fluidic dies. However, the use of foams as a fluid delivery mechanism also introduces other challenges. For instance, determining an amount of fluid in a porous media reservoir can be challenging. Fluids may travel relatively slowly though porous media and the distribution of fluid within the porous media is highly variable, for instance.

The approach of using conductive members (e.g., conductive pins or needles) at two ends of a fluid reservoir and correlating differences in resistance to different fluid levels within the reservoir may work well (e.g., differences in resistance may be measured relatively quickly and may represent fairly accurate measures of fill level) in non-porous media reservoirs. However, the inclusion of porous media in a reservoir may reduce accuracy of the correlation, such as due to uneven distribution of fluids through the porous media, slow movement of fluids through the porous media, and the limited range of saturation of the porous media surrounding the conductive members (e.g., to avoid the porous media surrounding the conductive members from being dry). Etc.

Alternatively, a pressure transducer may be used to measure pressure in the porous media reservoir. While a pressure transducer may offer desired accuracy, resolution, and measurement speed, pressure transducers may be comparatively expensive and take up valuable physical space in a system. And as such, at times, pressure transducers may not be an ideal means of measuring fluid level in a porous media reservoir.

With the foregoing in mind, the present description proposes the use of a novel structure and method to measure pressure (and thus, saturation or extractable fluid) within a porous media reservoir. Thus, in one example, a capillary structure may be used in fluid communication with the porous media reservoir. The capillary structure will have parameters (such as dimensions) that are tuned to correspond to parameters of the porous media reservoir such that there is a relationship between saturation or extractable fluid in the porous media reservoir and fluid level in the capillary structure. For instance, in one case, fluid in the capillary structure may respond to changes in pressure within the porous media reservoir, potentially falling below a threshold responsive to fluid exiting the porous media reservoir and remaining above a threshold while sufficient fluid remains in the porous media reservoir. As shall be discussed in greater detail hereinafter, the fluid level in the capillary structure may be sensed in a number of different ways (e.g., based on resistance, capacitance, optically, etc.), thus leading to an estimation of fluid level in the porous media reservoir.

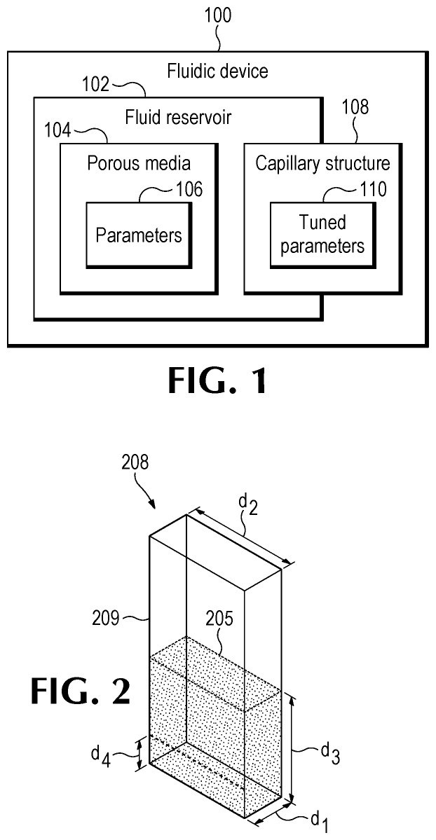

To illustrate the capillary structure-based porous media reservoir fluid level estimation system, FIG. 1 presents a block diagram including a fluidic device 100, a fluid reservoir 102 including a porous media 104, and a capillary structure 108 in fluid communication with fluid reservoir 102. As noted, above, fluidic device 100 may refer to a device to be used to eject a printing fluid onto a media (e.g., a paper, a build material, etc.). For instance, the fluidic device may be an inkjet cartridge, a printbar in a printing device (e.g., 2D or 3D printing device), or other like mechanism of applying printing fluid to a media. Of course, as should be appreciated, claimed subject matter is not limited to such uses of fluidic device 100. Other examples may include a platform for testing fluids for the presence of diseases (e.g., testing components of fluids, such as blood, by sorting cells by size, type, etc.) and like mechanisms that may manipulate fluids. In such examples, a porous media reservoir may hold fluids to be used, including blood, plasma, and other fluids (e.g., saline solutions, etc.).

Fluid reservoir 102 refers to a structure including a void within which fluid (e.g., printing fluid) may be stored and from which fluid may be pushed and/or pulled, such as by a fluidic die (e.g., a fluid ejection die). A porous media 104 may be arranged within fluid reservoir 102 and through the cells of which fluids may flow. For instance, porous media 104 may comprise an open- or closed-cell foam (e.g., polyurethane (PU), polyolefin fibers, or polyethylene (PE) foam, by way of non-limiting example). Porous media 104 may have a number of parameters 106, which may be used to characterize fluid flow through porous media 104. To illustrate, a first porous media 104 having a first set of parameters 106 may allow fluid to flow (e.g., in response to pressure and the force of gravity) at a first rate, while a second set of parameters 106 may allow fluid to flow at a second rate, etc. Porous media, such as solid foam, may allow flow of fluids in response to capillary effects. Indeed, the capillary effects may induce a negative pressure within the porous media. And parameters of the porous media may have an effect on the correlation between saturation of the porous media and pressure.

Capillary structure 108 refers to a structure, such as comprising a plastic or a glass body and within which a capillary channel is arranged. Parameters of capillary structure 108 may be selected to achieve desired functionality in response to operation of fluid reservoir 102 and porous media 104. For instance, the capillary channel within capillary structure 108 may define a fluid path through which fluid may flow in order to indicate fluid levels within fluid reservoir 102. In one implementation, capillary structure 108 may function as a binary full/not-full indicator. As such, fluid may remain above a threshold within capillary structure 108 as long as fluid level within reservoir 102 is greater than a threshold. However, as fluid within reservoir 102 drops below a threshold, fluid level within capillary structure 108 may fall below a threshold of the capillary structure. In such cases, capillary structure 108 may be used to indicate, among other things, that reservoir 102 should be refilled, that a replacement fluidic device 100 should be installed, etc. Of course, in some implementations capillary structure 108 may be include more than a binary full/not full indication. For instance, in some cases, capillary structure 108 may be capable of providing a number of thresholds and/or may provide analog indications of fluid fill level, without limitation. FIG. 2 and supporting discussion will provide additional detail as to tuned parameters 110 of capillary structure 108, but for the present discussion it is enough to understand that there is a relationship between the parameters of porous media 104 and reservoir 102 and the tuned parameters (e.g., dimensions, such as a fluid path dimension and/or a fluid fill threshold height, surface energy, etc.) of capillary structure 108 to enable capillary structure 108 of providing an indication of fill level within reservoir 102.

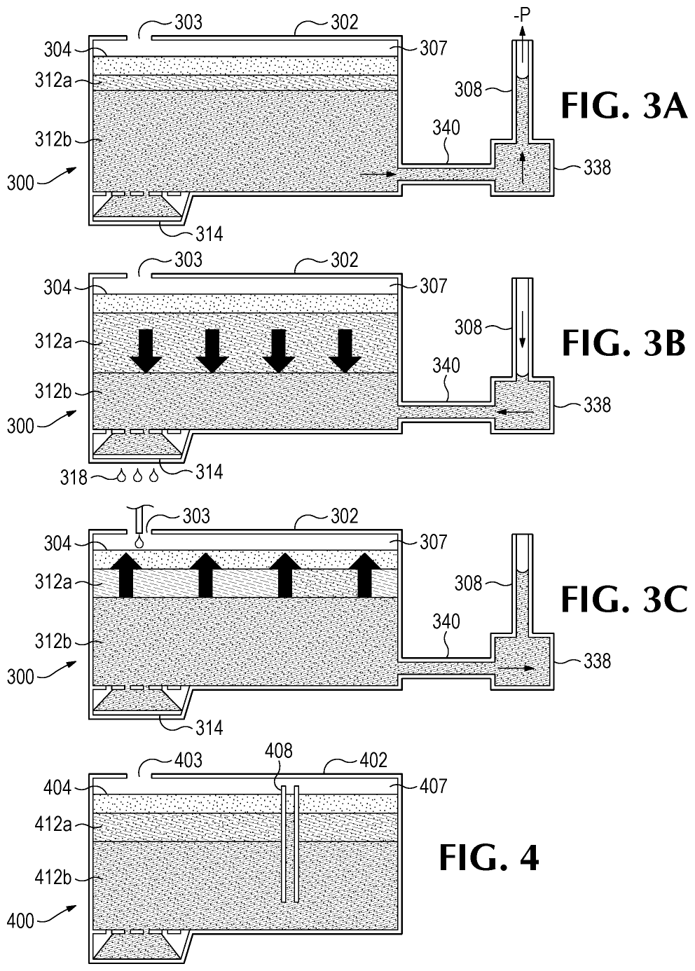

For example, the relationship between porous media 104 and capillary structure 108 may be such that fluid fill levels within capillary structure 108 will change in response to changes in pressure within capillary structure 108, as shall be discussed in further detail in relation to FIGS. 3A-3C. In some cases, for instance, negative pressure in reservoir 102 may become increasingly negative (e.g., as fluid is pulled out of reservoir 102 into an attached fluidic die) and fluid levels in capillary structure 108 may fall in response thereto. Conversely, at times, pressure in reservoir 102 may become less negative, such as in response to fluids being added to reservoir 102. In response, fluid levels in capillary structure 108 may increase.

In view of the foregoing, therefore, in one implementation, a fluidic device (e.g., fluidic device 100) may include a fluid reservoir (e.g., fluid reservoir 102) having a porous media (e.g., porous media 104) arranged therein, and a capillary structure (e.g., capillary structure 108) in fluid communication with the porous media and the fluid reservoir. The capillary structure has tuned parameters (e.g., tuned parameters 110) corresponding to parameters (parameters 106) of the fluid reservoir and the porous media. As such, fluid within the capillary structure will change level in response to pressure changes in the reservoir caused by changes in saturation. As noted, above, the porous media may include PU foam.

FIG. 2 illustrates a fluid path 209 of a capillary structure 208 (compare with capillary structure 108 of FIG. 1). For simplicity, the outer structure is not illustrated, leaving only fluid path 209. In the example illustrated in FIG. 2, fluid path 209 is illustrated as having a rectangular cross section, of course other forms of fluid paths are also contemplated as long as the parameters are tuned to enable use of the capillary structure to indicate fluid level within a fluid reservoir. A fluid 205 is illustrated within fluid path 209. In this example, a lower portion of fluid path 209 is in closer fluidic proximity to a fluid reservoir (e.g., fluid reservoir 102 of FIG. 1) than an upper portion of fluid path 209, which is open to atmosphere. As such, fluid 205 is concentrated at the lower portion of fluid path 209.

FIG. 2 also includes notations of dimensions of fluid path 209. A first dimension, d₁, represents a depth of fluid path 209 into and out of the page and represents a dimension of particular interest in tuning the capillary structure to the reservoir. A second dimension, d₂, represents a width of fluid path 209 across the page. And a third dimension, d₃, represents a height of fluid 205 within fluid path 209 of capillary structure 208. D₃ may refer to a threshold representing a full state. In some cases, another fill level (shown as d₄) may represent a lower threshold below which the reservoir is considered to be in an empty state. For example, parameters of capillary structure 208 may be tuned such that fluid in fluid path 209 reaches d₃ in response to pressure within the fluid reservoir being approximately −1 inches H₂O (e.g., a “full” threshold). In another example, the threshold may correspond to approximately −2 inches H₂O. And a lower threshold, such as d₄, may correspond to a pressure in the reservoir corresponding to approximately −4 or −5 inches H₂O, by way of non-limiting example, which may correspond to a capillary pressure in the porous media of the reservoir of an “empty” state. In this example, these example dimensions may be selected based on parameters of a porous media, a fluid reservoir, and/or a fluid type in order to yield a capillary structure 208 capable of indicating fluid level within the porous media fluid reservoir.

In this example, a correspondence is established between pressure within the fluid reservoir (e.g., fluid reservoir 102 in FIG. 1) and fluid path 209 of capillary structure 208. This correspondence may be governed by the following expression:

$${P}_{res ervoir \_ full} = \frac{2 δ cos θ}{2 {d}_{1}} + ρ g {d}_{3} \qquad Expression 1$$

The values of Expression 1 include:
P_{reservoir_full}, which refers to the pressure in the reservoir in a full state. In some cases, the pressure in the reservoir at a full state may be determined empirically, and Expression 1 may be used to solve for the dimensions of fluid path 209 of capillary structure 208.
δ, which refers to the surface tension of fluid 205. Different fluids exhibit different surface tension values. For instance, water has a surface tension of approximately 72.8 mN/m at 20° C. By way of further example, some printing fluids may have surface tensions on the order of 20 or 45 mN/m. And the values may vary across different types or colors of printing fluids (e.g., printing fluid having black colorant may have a different surface tension than printing fluid having cyan colorant, etc.), without limitation.
θ, which refers to the contact angle of fluid in fluid path 209. Contact angle may depend on the surface energy of the interior of capillary structure 208 and the surface tension of the fluid in the porous media. For instance, if the surface energy for a structure approximate the surface tension of the fluid, then the contact angle ranges from 0 to 90 degrees. If the surface energy is less than the surface tension, then θ is greater than 90 degrees and the expression goes negative (indicating fluid repulsion by the capillary structure). For a given size capillary structure, it may be possible to maximize the capillary pressure by pushing the cosine value to 1, which is represented by a contact angle of 0. This may be accomplished by making the surface energy of the structure significantly greater than the surface tension of the fluid. Additionally, there may be interest in an interior surface that is as wettable as possible to achieve a lower contact angle. This may include the use of a plasma-treated surface for plastic capillary structures.
ρ, which refers to the density of fluid. The density varies by fluid. For instance, some printing fluids may have a density on the order of 1.0 to 1.1 g/cm³. By comparison, water has a density of approximately 1 g/cm³ and binding agents for additive manufacturing may be on the order of approximately 2 g/cm³.
g, which refers to the acceleration due to gravity. The acceleration due to gravity varies depending on altitude and may be between 9.76 and 9.83 m/s² at different altitudes on the earth's surface.
And d₃, which refers to the desired fluid threshold height in fluid path 209. The value for d₃ may be selected to be approximately in a middle of capillary structure 208.
   With the foregoing in mind, parameters for capillary structure 208 may be selected to yield indications of fill level. Additionally, in a particular capillary structure setup, a lower threshold (e.g., d₄) may be determined empirically.

It should be understood that based on tuned parameters, fluid level within fluid path 209 will reach or cross a threshold in response to the fluid reservoir reaching a “full” state. And in some cases, fluid level within fluid path 209 may reach or cross a lower threshold (e.g., d₄) in response to fluid reservoir reaching an “empty” state. It should be appreciated that in a full state, there may nevertheless still be room within the reservoir for additional fluids and likewise that in an empty state there may nevertheless remain small volumes of fluids (e.g., such as to potentially avoid damaging the fluidic die by attempts to actuate fluid actuators while in an empty state).

As discussed above, the use of a capillary structure in fluid communication may be desirable, such as to provide an indication of fluid levels within a fluid reservoir. FIGS. 3A-3C illustrate operation of one fluidic device 300, according to one implementation. It is noted that like numbered elements (e.g., 100 and 300) are to be understood as being similar in structure and/or operation. For instance, fluidic device 300 is to be understood as having a structure and/or operation that is similar to that of fluidic device 100 in FIG. 1. It is noted, however, that particular aspects of later elements are not to be read back into earlier elements. For instance, fluidic device 300 of FIG. 3A-3C is illustrated as being a fluidic device of a printing device. But fluidic device 100 is not necessarily part of a printing device. Additionally, in some cases, aspects of one implementation are not intended to be applied to all similar elements. For instance, in one implementation, fluidic device 300 of FIGS. 3A-3C may be discussed in the context of a thermal inkjet (TIJ) printing device, but this example is not intended to limit the scope of other (e.g., earlier and/or later) examples to TIJ devices. Instead, these implementational details are provided to more fully illustrate a particular example without limitation.

Returning to FIGS. 3A-3C, fluidic device 300 is illustrated at different discrete points in time. For example, FIG. 3A illustrates a point in time at which capillary structure 308 is filled, FIG. 3B illustrates a point in time at which fluidic device 300 is used to eject fluid, and FIG. 3C illustrates a point in time at which fluidic device 300 is refilled.

As illustrated, fluidic device 300 is illustrated as having a fluid reservoir 302 with porous media 304 arranged therein. An air gap 307 is illustrated above porous media 304. Within porous media 304, fluid may be of different concentrations, such as due to gravity. For instance, in the example illustrated in FIG. 3A, a lower portion 313B of porous media 304 is fully saturated, while a smaller upper portion 313A of porous media 304 is more lightly saturated. Of course, it is to be understood that rather than two distinct regions of saturations, saturation of porous media 304 may be more gradient-like in some implementations.

Capillary structure 308 is illustrated in fluid communication with fluid reservoir 302 via an intermediate porous media chamber 338 and a fluid passage 340. Intermediate porous media chamber 338 may comprise a same or similar porous media as porous media 304 (e.g., such that tuned parameters of capillary structure correspond with porous media 304 and the porous media of intermediate porous media chamber 338). It is noted that a lower portion of capillary structure 308 is thus in closer fluidic proximity to fluid reservoir 302 than an upper portion of capillary structure 308. A fluid inlet 303 is also illustrated in a top portion of reservoir 302 and through which additional fluid may be added to reservoir 302 (FIG. 3C).

Fluidic device 300 is also illustrated as having a fluidic die 314, which ejects fluids (ejected fluid droplets 318), as illustrated in FIG. 3B. Ejection of fluid may be enabled by fluid actuators, such as thermal resistive or piezoelectric elements, by way of non-limiting example. For example, fluidic die 314 may include a number of fluid channels (e.g., microchannels) through which fluids may travel towards ejection chambers. Actuators may be arranged within the ejection chambers in order to cause fluid droplets to exit orifices (e.g., nozzles) of fluidic die 314. In one example, as fluid droplets are ejected from fluidic die 314, additional fluid may be pulled into fluidic die 314 from fluid reservoir 302 due, at least in part, to capillary forces to replace fluid volumes ejected. In other examples, reservoir 302 may also be pressurized (e.g., primed) such that as fluids are ejected from fluidic die 314, corresponding amounts of fluids are drawn into fluid reservoir 302 from an external source. Additionally, some examples may further include a fluidic pump to push fluid into fluid reservoir 302 in addition to the fluidic forces due to capillary effects at fluidic die 314.

Capillary structure 308 may need to be calibrated as part of a setup process. For instance, in one case, fluidic device 300 may be shipped in an “empty” state in which no fluid (or only shipping fluid) is present in reservoir 302. In such examples, capillary structure 308 may not be filled with fluid or may not have fluid present at desired levels. Thus, upon installation in a system (e.g., printing system), capillary structure 308 may have to be calibrated to represent fluid level within reservoir 302. Of course, in other cases, fluidic device 300 may be calibrated prior to shipping, and thus an initial calibration of capillary structure 308 may not be necessary. FIG. 3A illustrates an initial calibration stage in which fluid is pulled into capillary structure corresponding to (and indicative of) fluid level of fluid reservoir 302. For example, fluid reservoir 302 may be filled and primed (e.g., pressurized and prepared for operation of fluidic die 314). Priming of fluid reservoir 302 may include engendering backpressure in fluid reservoir 302. In order to cause fluid to flow into capillary structure 308, capillary structure 308 may have to be pressurized separately (e.g., application of a pressure such that a pressure—a negative pressure—in capillary structure 308 is greater—more negative—than that of fluid reservoir 302). Further, in cases in which capillary structure 308 is external to reservoir 302, a vacuum may be applied to capillary structure 308 to cause saturation of an intermediate porous media chamber 338 and filling of capillary structure 308. Thus, fluid may flow into capillary structure 308 while the pressure (e.g., negative pressure) in capillary structure 308 is greater (e.g., more negative in the context of a negative pressure) than the pressure (e.g., negative pressure) in fluid reservoir 302, as represented by P_{C}Porous media<P_{C}Capillary, where the subscript “C” indicates that the pressure is a comparison of the capillary pressure in the porous media versus the capillary pressure in the capillary structure. FIG. 3A illustrates fluid flow using arrows, from fluid reservoir 302 to fluid passage 340, out of intermediate porous media chamber 338, and within capillary structure 308. This indication of fluid flow may be due to pressure imbalance, as fluid seeks to move into capillary structure 308 to achieve an equilibrium state. As noted, previously, parameters of capillary structure 308 may be tuned in order to achieve desired fill levels within capillary structure 308 in response to fluid levels within fluid reservoir 302.

Moving to FIG. 3B, an illustration of operation of fluidic device 300 while ejecting fluid droplets 318 from fluidic die 314. In response to capillary action in fluidic die 314 as fluid droplets 318 are ejected, fluid within reservoir 302 is pulled into and towards fluidic die 314, as illustrated by the arrows above the lower portion 312b. In addition to affecting pressure within fluid reservoir 302, the capillary action also causes fluid to leave capillary structure 308 and intermediate porous media chamber 338, as illustrated by the arrows in capillary structure 308 and intermediate porous media chamber 338. Fluid levels in capillary structure 308 may be indicative of the decreased fluid levels in fluid reservoir 302. Indeed, as illustrated, portion 312b, which is saturated with fluid, is smaller in FIG. 3B as contrasted with portion 312b in FIG. 3A. The operation of fluidic device 300 may be described by the inequality P_{C}Porous media>P_{C}Capillary, wherein, again, P_{C}Porous media is more negative than the capillary pressure represented by P_{C}Capillary.

As shown in FIG. 3C, as fluid is added to fluid reservoir 302 (e.g., see drops entering via fluid inlet 303), saturation of porous media 304 increases (e.g., as shown by increasing size of portion 312b and the arrows above portion 312b and over portion 312a). The added fluid may cause capillary pressure in porous media to become less negative. The operation of fluidic device 300 as illustrated in FIG. 3C may be described by the inequality P_{C}Porous media<P_{C}Capillary, which describes the negative pressure of P_{C}Porous media becoming less negative than the negative pressure in capillary structure 308, described by P_{C}Capillary.

As discussed, parameters of capillary structure 308 are tuned in order to achieve the functionality discussed in the preceding paragraphs. At times, capillary structures external to the fluid reservoir may enable visual and/or optical level detection approaches. For instance, in one example, and as shall be discussed in greater detail hereinafter, capillary structure 308 may be installed in proximity to a window in the housing of fluid reservoir 302 in order to enable both user-based and optical fluid level sensing.

With the foregoing in mind, in one example fluidic device (e.g., fluidic device 300), the capillary structure (e.g., capillary structure 308) is arranged externally as to the reservoir (e.g., fluid reservoir 302) and the fluidic device further comprises an intermediate porous media chamber (e.g., intermediate porous media chamber 338). The intermediate porous media chamber is in fluid communication with the reservoir, and the capillary structure is in fluid communication with the reservoir via the intermediate porous media chamber.

While FIGS. 3A-3C illustrate an implementation in which capillary structure 308 is external to fluid reservoir 302, FIG. 4 illustrates an implementation in which capillary structure 408 is arranged within fluid reservoir 402 of fluidic device 400. Parameters of capillary structure 408 may be tuned to achieve a fill level threshold within capillary structure 408 that corresponds to a “full” level within reservoir 402. For instance, in this example, portion 412b of porous media 404 is illustrated as being in a saturated state, while portion 412a is in a semi-saturated state. This state of saturation may be considered, in some examples, as corresponding to “full,” and dimensions of a fluid path of capillary structure 408 may be selected to achieve the fill level illustrated in FIG. 4. And additional fluid may be added via fluid inlet 403.

While this implementation may be beneficial as contrasted with implementations in which a capillary structure is external to the fluid reservoir (see, e.g., FIGS. 3A-3C), it may raise challenges, as well, such as reading fluid level within the capillary structure. For instance, in an internal capillary structure implementation, level sensing implementations that use electromechanical means may use additional structure (e.g., electronics, leads, etc.) within the reservoir, which may add complexity to the device.

With the foregoing in mind, in one example fluidic device (e.g., fluidic device 400), the capillary structure (e.g., capillary structure 408) may arranged within a fluid reservoir (e.g., fluid reservoir 402) and a first end of the capillary structure is in proximity with a bottom portion (e.g., portion 412b) of the reservoir and a second end of the capillary structure is in proximity to a top portion of the reservoir (e.g., above portion 412a) within an air gap 407 (which may be at atmospheric pressure).

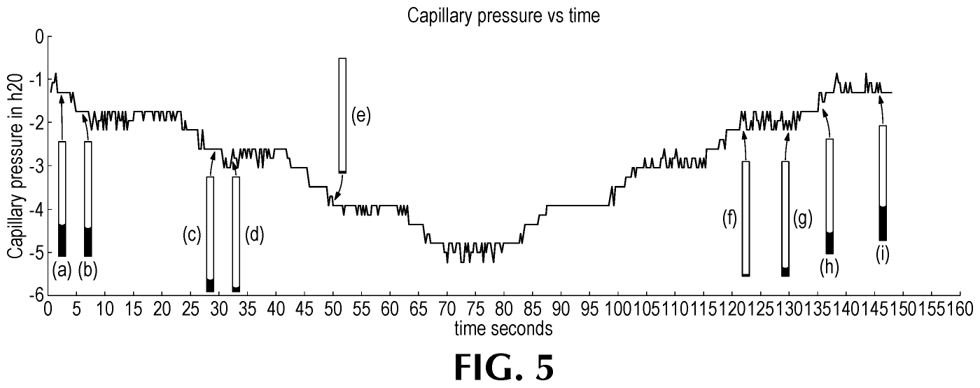

FIG. 5 is a chart illustrating pressure readings in a fluid reservoir (e.g., fluid reservoir 302 or 402 in FIGS. 3A-3C or 4, respectively) corresponding to fluid levels in a capillary structure (e.g., capillary structure 308 or 408). These example readings are based on experimental data and illustrate a relationship between fluid level in a capillary structure in fluid communication with a porous media fluid reservoir. Indeed, FIG. 5 compares the passage of time while firing actuators of a fluidic die to eject fluid droplets with capillary pressure within a porous media of a fluidic device. It is noted that the passage of time is merely used to assist in identifying fill levels. Of greater interest is the fact that as the capillary pressure within the fluid reservoir decreases from −1 to −5 inches H₂O, the capillary structure starts to drain (see, e.g., (a), (b), (c), and (d)) such that by −4 inches H₂O it has reached a nearly empty state (see, e.g., (e)). FIG. 5 also shows that the capillary structure remains in the nearly empty state (see, e.g., the gap between (e) until (f)) until the capillary pressure of the reservoir returns to −2 inches H₂O (see, e.g., (g)). at which point it continues to fill as the pressure in the reservoir returns to −1 inches H₂O (see, e.g., (h) and (i)). In practice, whether or not the capillary structure refills depends on whether the pore(s) in fluid communication with the fluid path of the capillary structure still has fluid (e.g., and thus maintains pressure within the capillary structure). If the relevant pore(s) of the porous media dry out however, a vacuum pressure will have to be applied to the capillary structure re-calibrate the capillary structure. Whether or not the pore(s) in question dry out, thus, can be approximated by using a pressure threshold. Said otherwise, a pressure threshold may be set corresponding to a likelihood that the pore(s) dries out and used as a shorthand or approximation of a point to avoid crossing, such as in terms of porous media saturation and capillary pressure. Using this approximation, the experimental behavior in FIG. 5 illustrates that the capillary structure operates as desired with respect to an example threshold negative pressure (e.g., −6 inches H₂O in one example, −9 inches H₂O in another, etc. depending on the particular tuned parameters of the capillary structure) within the reservoir.

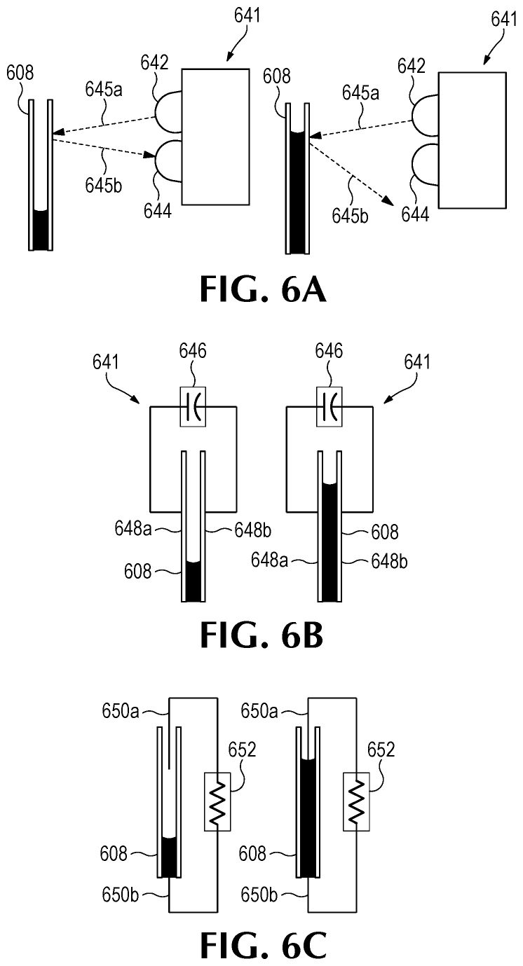

FIGS. 6A-6C illustrate a number of fluid level detection implementations for determining whether fluid in the capillary structure corresponds to a full or non-full state. FIG. 6A illustrates an optical sensing-based implementation; FIG. 6B illustrates a capacitive sensing-based implementation; and FIG. 6C illustrates a resistive sensing-based implementation. Of course, other implementations of fluid sensing are possible (e.g., a MEMS-based sensing system), and these examples are merely presented by way of illustration.

FIG. 6A shows two views: a not-full view on the left and a full view on the right. In the not-full state of capillary structure 608, electromagnetic radiation (EMR) is emitted from an emitter 642 of a sensor 641. The dotted line and arrow 645a refer to emitted EMR (e.g., light), transmitted towards a threshold fill area of capillary structure 608. The dotted line and arrow 645b refer to reflected EMR, reflected back from capillary structure 608. In one implementation, sensor 641 and capillary structure 608 may be arranged such that EMR is reflected to detector 644 while capillary structure 608 is in a full state. But in another implementation, sensor 641 and capillary structure 608 may be arranged such that EMR is reflected back to detector 644 while capillary structure 608 is in a not-full state. FIG. 6A illustrates the latter implementation. As shown by the not-full illustration on the left, EMR is reflected back to detector 644 upon reflection off of an empty portion of capillary structure 608. This is contrasted with the full state illustrated on the right in which EMR is reflected back so as to not be detected by detector 644.

FIG. 6B also illustrates a not-full state (on the left) and a full state (on the right) of capillary structure 608 along with a capacitance detection approach. Capacitive sensor 646 represents a mechanism capable of detecting and measuring capacitance across conductive plates 648a and 648b. Changes in capacitance will occur as fluid levels within the capillary structure move back and forth between a full and a not-full state.

FIG. 6C illustrates a not-full state of capillary structure 608 on the left, and a full state of capillary structure 608 on the right. In this implementation of level sensing, a resistive sensor 652 will measure changes in resistance based on changes in fill level within capillary structure 608. Thus, a first resistance value may correspond to a not-full state, while a second resistance value may correspond to a full state. In any case, a plurality of conductive elements (e.g., conductive elements 650a and 650b) may be arranged in the capillary structure in order to determine fill level of capillary structure 608 (e.g., in fluid contact).

The result of level sensing in capillary structure may be represented in the form of electrical signals or state, and may be transmitted, such as external to a fluidic device. For instance, based on measured fill levels, a system may be capable of filling a fluid reservoir, ceasing to fill a reservoir, providing a user-identifiable indication of low fill level, and the like.

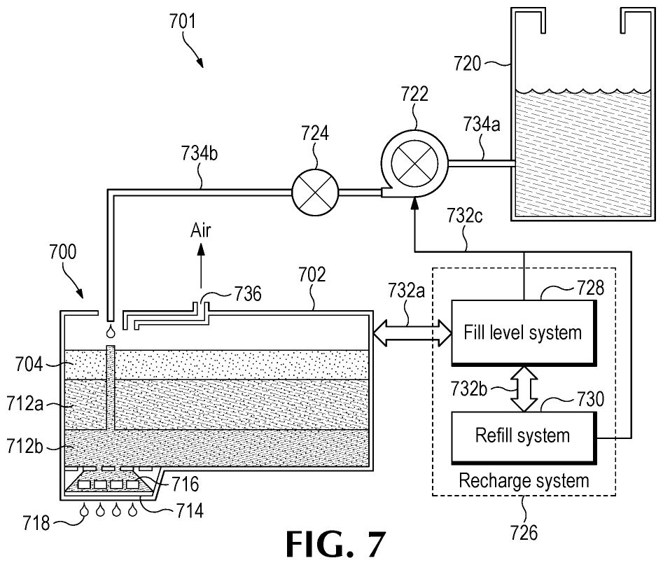

With the foregoing in mind, FIG. 7 illustrates how a fluidic device (e.g., fluidic device 100 of FIG. 1) may operate within a larger system, fluidic system 701. Fluidic system 701 includes a fluidic device 700, similar in structure and function to previous fluidic devices (e.g., fluidic device 100 of FIG. 1 and the like). Fluidic device 700 is in fluidic communication with a fluid supply 720 via fluid lines 734a and 734b. A pressurization mechanism 722 (e.g., a pump) is illustrated between fluid supply 720 and fluidic device 700 and may operate to engender fluid flow from fluid supply 720 towards fluidic device 700. Further, a valve 724 is also arranged between pressurization mechanism 722 and fluidic device 700, such as to maintain pressure within fluidic device 700.

Fluidic device 700 and pressurization mechanism 722 communicate (e.g., exchange electric signals) with a recharge system 726 to detect, manage, and control fluid level in fluidic device 700. For instance, 732a-732c represent signals exchanged (e.g., via control lines). Signals indicative of fluid level in fluidic device 700 may be transmitted by 732a, due to which, recharge system 726 may transmit signals to pressurization mechanism 722 via 732c. In response, pressurization mechanism may operate to pull fluid from fluid supply 720, via fluid line 734a, through valve 724 and fluid line 734b and into fluid reservoir 702. Air valve 736 refers to a mechanism to selectively release air from fluid reservoir 702. At times, for instance, air may be trapped in fluid delivered to fluidic device 700, such as in the form of bubbles. As the bubbles burst, the air may be released and reservoir 702 may push the air out via air valve 736 (e.g., actively or passively).

A capillary structure (not shown in FIG. 7) may be used to determine fluid level within fluid reservoir 702. For instance, as illustrated in FIG. 7, portion 712b represents a saturated portion of porous media 704 (and portion 712a a semi-saturated portion of porous media 704). The capillary structure may enable a determination that this state of saturation is lower than desired, and signals may be transmitted to pressurization mechanism 722 from recharge system 726, which may lead, in turn, to fluid being pumped into fluid reservoir 702, as illustrated.

FIG. 7 illustrates actuators 716 which may cause fluid to be ejected, as illustrated by fluid droplets 718. As discussed above, ejecting fluid droplets via fluidic die 714 may cause fluid to be pulled out of fluid reservoir 702. And a capillary structure may be capable of detecting such changes, responsive to which, signals may be transmitted to recharge system 726 for management of fluid levels within fluid reservoir 702.

It is noted that recharge system 726 includes two modules: a fill level system 728 and a refill system 730. Fill level system 728 refers to a combination of hardware and/or software (but not software per se) capable of correlating the signals indicative of fill level of the capillary structure into fill level of fluid reservoir 702. Meanwhile, refill system 730 refers to a combination of hardware and/or software (but not software per se) that use signals from fill level system 728 (e.g., received as illustrated by 732b) to determine whether to pump additional fluid from fluid supply 720 into fluidic device 700. Refill system 730 can also determine whether pressurization mechanism 722 needs to be stopped (e.g., fluidic device 700 having reached a full state).

With the foregoing in mind, one example printing fluid ejection device (e.g., fluidic system 701) may include a reservoir (e.g., fluid reservoir 702) with a porous media (e.g., porous media 704) arranged therein. The printing fluid ejection device may also include a fluid ejection die (e.g., fluidic die 714) and a capillary structure (e.g., capillary structure 308 of FIGS. 3A-3C). The fluid ejection die is in fluid communication with the reservoir and is arranged to draw printing fluid from the reservoir and eject droplets (e.g., fluid droplets 718) of printing fluid to an exterior of the printing fluid ejection device. The capillary structure is in fluid communication with a portion of the reservoir in which the printing fluid is concentrated (e.g., portion 712b). The capillary structure also has tuned parameters corresponding to parameters of the reservoir and the porous media such that printing fluid is to remain in the capillary structure while pressure in the fluid reservoir changes less than a threshold (see, e.g., the discussion of FIGS. 2 and 3A-3C).

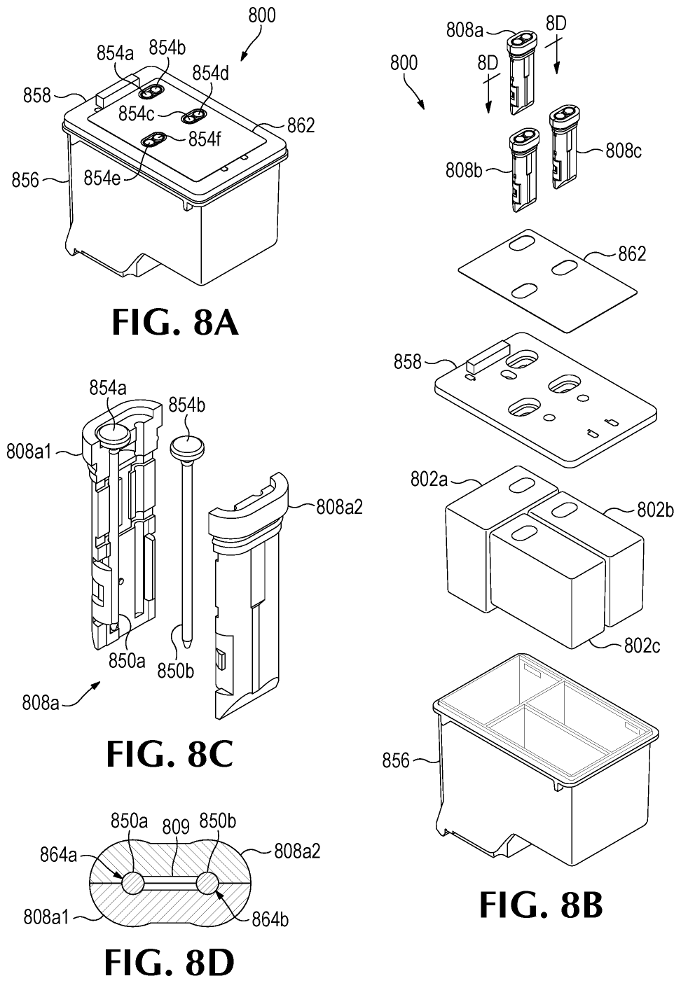

FIGS. 8A-8D illustrate an implementation of a fluidic device (fluidic device 800) for which a capillary structure (capillary structures 808a-808c; collectively 808) is arranged within a fluid reservoir (e.g., fluid reservoirs 802a-802c; collectively 802), as described above in relation to FIG. 4.

FIG. 8A illustrates a housing 856 within which fluid reservoirs 802 are arranged, along with corresponding capillary structures 808. A lid 858 is placed over the top of housing 856 to fully enclose fluid reservoirs 802. In this implementation, fluid level within capillary structures 808 may be determined using a resistive sensor, and the signals indicative of resistive values (and corresponding to fill level) may be received via electrical interconnects 854a-854f. Label 862 refers to a top element to restrict access to portions of lid 858 and provide information (e.g., item numbers, logos, warnings, etc.) among other things.

FIG. 8B illustrates fluid reservoirs 802a-802c, each corresponding to a different fluid as exploded out of housing 856. Lid 858 and label 862 are also shown as part of the exploded view, separate from housing 856. Capillary structures 808a-808c for each of fluid reservoirs 802a-802c, respectively. A lower portion of capillary structures 808a-808c may be open and in fluid communication with porous media (e.g., porous media 704 of FIG. 7). FIG. 8B illustrates a direction (call out 8D-8D) of cross-sectional view shown in FIG. 8D, which shows capillary structure 808a divided into two halves, a first half 808a1 and a second half 808a2. Within these two halves, conductive elements 850a and 850b are housed within pin holes 864a and 864b, respectively. Pin holes 864a and 864b are arranged in proximity to fluid path 809 to enable taking measurements of resistivity to enable measurement of fluid level within capillary structure 808.

FIG. 8C is an exploded view of capillary structure 808a showing how the two halves, 808a1 and 808a2 include features to form fluid path 809 and pin holes 864a and 864b within which conductive elements 850a and 850b may be arranged. A top portion of conductive elements 850a and 850b include electrical interconnects 854a and 854b, while the lower portion may comprise conductive pins. The electrical interconnects 854a and 854b are to be arranged with respect to lid 858 to enable exchange of signals between conductive elements 850a and 850b and external devices, such as recharge system 726 of FIG. 7.

As should be apparent from the foregoing, example fluidic devices (e.g., fluidic device 800 in FIG. 8) may include a plurality of conductive elements (e.g., conductive elements 850a, 850b, and remaining conductive pins associated with electrical interconnects 854c-854f) that comprise conductive pins arranged in pin holes (e.g., pin holes 864a, 864b, and the remaining pin holes associated with electrical interconnects 854c-854f) at opposing ends of a fluid path (e.g., fluid path 809) of the capillary structure.

Another example fluidic device (e.g., fluidic device 800) may include a pair of conductive sensors (e.g., conductive elements 850a and 850b) and electrical interconnects (e.g., electrical interconnects 854a and 854b). The pair of conductive sensors are arranged within a capillary structure (e.g., capillary structure 808). The electrical interconnects are to be arranged on a surface of a housing (e.g., lid 858) of the fluidic device and in electrical communication with the pair of conductive sensors to enable an electrical connection (e.g., arrow 732a in FIG. 7) to the pair of conductive sensors from external to the printing fluid ejection device (e.g., as illustrated in FIG. 7).

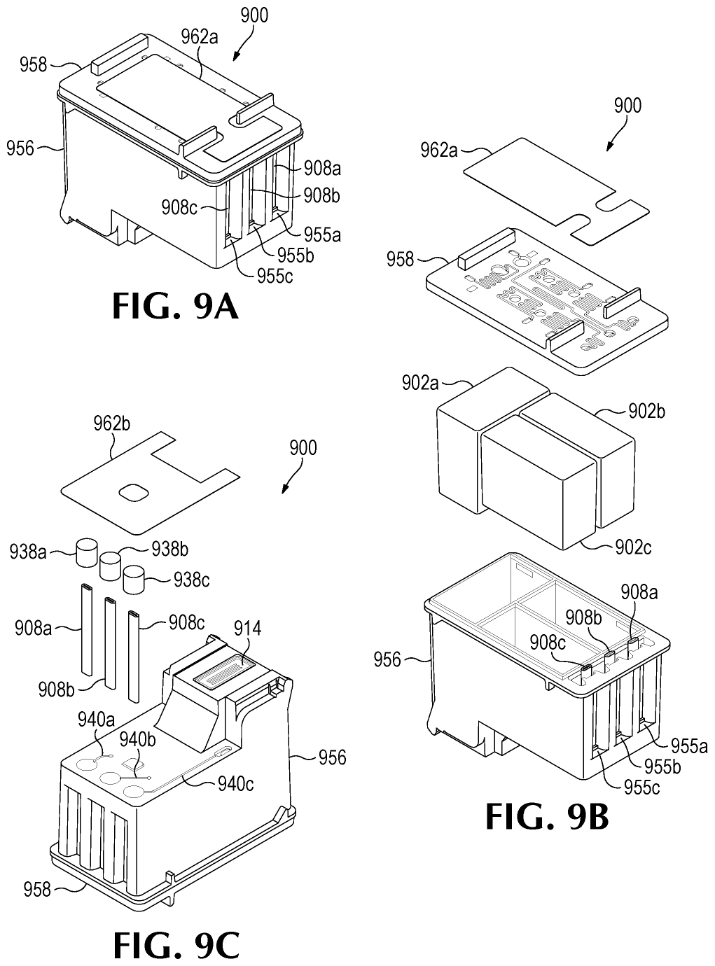

FIGS. 9A-9C illustrate an implementation of a fluidic device, fluidic device 900, using an optical sensing-based approach to sensing fluid level within a capillary structure (e.g., capillary structures 908a-908c; collectively capillary structures 908). FIG. 9A illustrates fluidic device 900 comprising a housing 956 within which fluid reservoirs and capillary structures (e.g., capillary structures 908a-908c) are arranged and are visible through housing windows 955a-955c. Similar to the implementation of FIGS. 8A-8D, housing 956 includes a lid 958 and a label 962a.

FIG. 9B is an exploded view of fluidic device 900 illustrating fluid reservoirs 902a-902c (collectively 902), each to contain a different fluid. Contrasted with reservoirs 802 in FIG. 8, reservoirs 902 do not include capillary structures 908 arranged therein. Instead, similar to FIGS. 3A-3C, an intermediate porous media chamber (e.g., intermediate porous media chambers 938a-938c; collectively 938) is used and arranged between capillary structures 908 and reservoirs 902. In this implementation, capillary structures 908 are arranged toward a front portion of housing 956 in order to enable viewing fluid level via housing windows 955a-955c. As such, capillary structures 908 may be of a transparent or translucent material to enable viewing/determining fluid level.

FIG. 9C illustrates an underside of housing 956 to show fluidic die 914 through which fluid may be ejected to the exterior of housing 956. The view of FIG. 9C also shows intermediate porous media chambers 938a-938c and corresponding fluid passages 940a-940c. As described above, capillary structures 908a-908c are in fluid communication with porous media reservoirs 902a-902c, respectively, via intermediate porous media chambers 938a-938c and fluid passages 940a-940c. A label 962b is included to cover portions of fluidic device 900 (e.g., access to intermediate porous media chambers 938a-938c) and/or provide information (e.g., logos, etc.).

With the foregoing in mind, an example fluidic device (e.g., fluidic device 900) may include a housing (e.g., housing 956) comprising openings (e.g., housing windows 955a-955c) through which capillary structures (e.g., capillary structures 908a-908c) are visible from the exterior of the housing to enable fluid level detection within the capillary structure by an optical sensor (e.g., optical sensor 641 of FIG. 6A) arranged in proximity to the capillary structure.

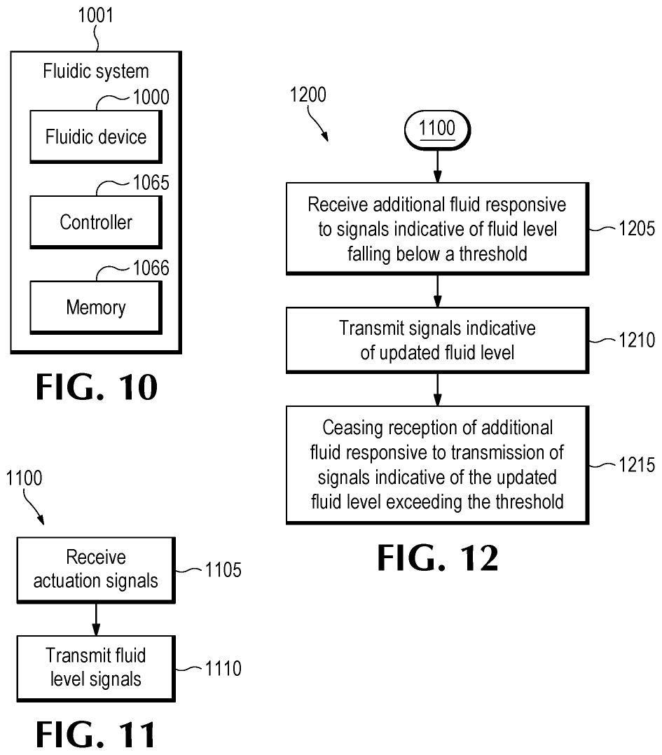

The above description refers to exchanging signals, ejecting fluid droplets, operating pressurization mechanisms, and the like. FIG. 10 is a block diagram that illustrates components of a fluidic system 1001 to enable such functionality. Fluidic system 1001 comprises a fluidic device 1000, a controller 1065, and a memory 1066.

Controller 1065 refers to a combination of hardware and software (but not software per se) capable of executing instructions to enable functionality associated with the instructions. For instance, example instructions may include instructions to determine fluid level within a capillary structure, instructions to turn on and off a pressurization mechanism, instructions to actuate fluid actuators to cause ejection of fluid droplets, etc. Controller 1065 may comprise one or more processing mechanisms, such as field programmable gate arrays (FPGAs), application-specific integrated circuits (ASICs), and general-purpose processors, by way of non-limiting example. Memory 1066 refers to structure capable of storing signals or states, and may include volatile and non-volatile memory including, without limitation, random access memory (RAM), read-only memory (ROM), magnetic memory, phase change memory, and the other suitable means of storing signals, states, and values. Memory 1066 may store instructions and values and may transmit the stored instructions and values to controller 1065 to enable operation of fluidic system 1001. In addition to the operation discussed above (e.g., of determining fluid levels within porous media fluid reservoirs using capillary structures and using such determinations to operate systems), fluidic system 1001 may enable the functionality discussed in FIGS. 11 and 12.

Indeed, FIG. 11 illustrates an example method 1100 for determining fluid level of a fluidic device (e.g., fluidic device 1000 of FIG. 10). At block 1105, signals indicative of actuation of fluid actuators may be received at the fluidic device. Actuation of fluid actuators may induce movement of fluid within a fluid ejection die (e.g., fluidic die 914 of FIG. 9). As illustrated at block 1110, signals indicative of fluid level of a capillary structure (e.g., capillary structure 908 of FIG. 9) in fluid communication with a porous media fluid reservoir (e.g., reservoir 902) of the fluidic device may be transmitted. For instance, the signals may be transmitted to controller 1065, and may enable the functionality discussed above in relation to fill level system 728 of FIG. 7. This may include determining a correlation between detected fill level and fluid level within the porous media fluid reservoir. In some cases, controller 1065 may perform this calculation. In other cases, this may include using a look-up table (LUT) stored in memory 1066.

Turning to FIG. 12, another example method 1200 is illustrated. Method 1200 is illustrated as following on method 1100. At block 1205, additional fluid may be received in the fluid reservoir responsive to signals indicative of fluid level falling below a threshold. For instance, fluid level in a capillary structure may be lower than a threshold, and controller 1065 may cause functionality of a refill system (refill system 730 in FIG. 7) in order to cause a pressurization mechanism (pressurization mechanism 722 in FIG. 7) to push fluid into the fluidic device from a fluid supply (e.g., fluid supply 720). Block 1210 illustrates additional signals being transmitted, this time indicative of an updated fluid level of the capillary structure. For instance, controller 1065 may receive signals (e.g., via electrical interconnects 854a-854f of FIG. 8A) and may determine a correlation between the received signals and fluid level in the fluid reservoir. An updated fluid level within the fluid reservoir may be determined. Block 1215 illustrates a stage at which the pressurization mechanism ceases to transmit additional fluid to the fluidic device. The ceasing to receive additional fluid is in response to the signals transmitted at block 1210. Indeed, the controller, upon determining that the fluid level exceeds a threshold (e.g., corresponding to a “full” state), may transmit signals to the pressurization mechanism to cease pumping fluid.

The foregoing description provides an approach to determining fluid levels in porous media fluid reservoirs using capillary structures.

It is noted that the foregoing description uses terms like “and/or,” “at least,” “one or more,” and other like open-ended terms in an abundance of caution. However, this is done without limitation. And unless expressly stated otherwise, singular terms (e.g., “a,” “an,” or “one” component) are not intended to restrict to only the singular case but are intended to encompass plural cases as well. Similarly, “or” is intended to be open-ended, unless stated otherwise, such that “A or B” may refer to A only, B only, and A and B.

Additionally, terms like “top” and “bottom” are used, above, merely to facilitate description and should not be understood in a limiting sense. For instance, the “top” of a capillary structure referred to, above, is used to distinguish other parts of the capillary structure as illustrated in the drawings, but not necessarily as the capillary structure may be used consistent with claimed subject matter.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A fluidic device comprising:
a fluid reservoir having a porous media arranged within the reservoir; and
a capillary structure in fluid communication with the porous media and the fluid reservoir and having tuned parameters corresponding to parameters of the fluid reservoir and the porous media, wherein fluid within the capillary structure to change level in response to pressure changes in the reservoir.

2. The fluidic device of claim 1, wherein the capillary structure is arranged within the fluid reservoir and a first end of the capillary structure is in proximity with a bottom portion of the reservoir and a second end of the capillary structure is in proximity to a top portion of the reservoir.

3. The fluidic device of claim 1, wherein the capillary structure is arranged externally as to the reservoir and the fluidic device further comprises an intermediate porous media chamber, the intermediate porous media chamber in fluid communication with the reservoir and the capillary structure in fluid communication with the reservoir via the intermediate porous media chamber.

4. The fluidic device of claim 1, wherein a full threshold of the capillary structure corresponds to approximately −1 inch H₂O.

5. The fluidic device of claim 1 further comprising a plurality of conductive elements arranged in the capillary structure.

6. The fluidic device of claim 5, wherein the plurality of conductive elements comprise conductive pins arranged in pin holes at opposing ends of a fluid path of the capillary structure.

7. The fluidic device of claim 1, wherein the porous media comprises polyurethane (PU) foam.

8. The fluidic device of claim 1, wherein the tuned parameters of the capillary structure comprise a dimension of a fluid path and a fluid fill threshold height.

9. A printing fluid ejection device comprising:
a reservoir with a porous media arranged therein;
a fluid ejection die in fluid communication with the reservoir, the fluid ejection die arranged to draw printing fluid from the reservoir and eject droplets of printing fluid to an exterior of the printing fluid ejection device; and
a capillary structure in fluid communication with a portion of the reservoir in which the printing fluid is concentrated, wherein the capillary structure has tuned parameters corresponding to parameters of the reservoir and the porous media such that printing fluid is to remain in the capillary structure while pressure in the fluid reservoir changes less than a threshold.

10. The ejection device of claim 9 further comprising:
a pair of conductive sensors arranged within the capillary structure; and
electrical interconnects on a surface of a housing of the printing fluid ejection device and in electrical communication with the pair of conductive sensors to enable an electrical connection to the pair of conductive sensors from external to the printing fluid ejection device.

11. The ejection device of claim 9 further comprising:
a housing comprising openings through which the capillary structure is visible from the exterior of the housing to enable fluid level detection within the capillary structure by an optical sensor arranged in proximity to the capillary structure.

12. The ejection device of claim 11 further comprising:
an intermediate porous media chamber comprising a porous media, the intermediate porous media chamber in fluid communication with the reservoir and the capillary structure in fluid communication with the reservoir via the intermediate porous media chamber.

13. A method of using a fluidic device, the method comprising:
receiving signals corresponding with actuation of fluid actuators of a fluid ejection die to induce movement of fluid within the fluid ejection die; and
transmitting signals indicative of a fluid level of a capillary structure in fluid communication with a porous media fluid reservoir of the fluidic device.

14. The method of claim 13 further comprising receiving additional fluid in the porous media fluid reservoir in response to transmission of signals indicative that the fluid level of the capillary structure fell below a threshold.

15. The method of claim 14 further comprising:
transmitting signals indicative of an updated fluid level of the capillary structure, the updated fluid level exceeding the threshold; and
ceasing to receive additional fluid in the porous media reservoir in response to the transmission of the signals indicative of the updated fluid level exceeding the threshold.
